(19) United States
(12) Patent Application Publication
(10) Pub. No.: US 2021/0220931 A1
(43) Pub. Date: Jul. 22, 2021

(54) Non-toothed hard alloy tipped circular saw blade

(71) Applicant: Tao Chen, Nanjing (CN)

(72) Inventor: Tao Chen, Nanjing (CN)

(21) Appl. No.: 16/835,299

(22) Filed: Mar. 30, 2020

(30) Foreign Application Priority Data
Jan. 22, 2020 (CN) 202010075266.8

(51) Int. Cl. B23D 61/02

(52) U.S. Cl. CPC B23D 61/025

(57) ABSTRACT

The invention discloses a non-toothed hard alloy tipped circular saw blade, comprising: a non-toothed structure steel plate with smooth outer edge; a plurality of hard alloy tips arranged in ordered array along the outer edge of the steel plate and can be sharpened according to requirements. The invention further explains how to make local structural adjustment to the saw blade according to the basic principle of the invention under the conditions of welding with solder and without solder; the saw blade in the invention has wide market prospect in portable electric power tools and battery power tools, improving the safety, cutting accuracy and versatility of the saw blade remarkably.

### BACKGROUND OF THE INVENTION

### 1. Field of the Invention

The invention relates to the technical field of circular saw blades, specifically relating to a non-toothed hard alloy tipped circular saw blade.

### 2. Description of the Related Art

Currently, alloy circular saw blades as an accessory for electric power tools are widely used in modern manufacturing and construction industries. In the market, (1) traditional hard alloy saw blades have obvious tooth structure on the steel plate, which bear risk of the steel plate breakage, when equipped on high-speed portable electric power tools; (2) although currently there is a kind of carbide grits saw blade without tooth structure on the steel plate, the carbide grits it adopts don't have uniform shape and size, and are arranged in disorder, which lead to reduction of the cutting efficiency, poor cutting quality and a good deal of burrs.

A new non-toothed hard alloy tipped circular saw blade needs to be developed to further improve the safety of electric power tools, improve the cutting efficiency, prolong the cutting life, enhance the cutting quality and improve its market competitiveness.

### SUMMARY OF THE INVENTION

To solve above problems, the invention provides a non-toothed hard alloy tipped circular saw blade, comprising: a non-toothed structure steel plate with smooth outer edge.

A plurality of hard alloy tips arranged in ordered array along the outer edge of the steel plate and can be sharpened according to requirements.

The outer edge of the plate can be arranged with expansion slots.

Furthermore, a plurality of grooves are formed in the outer edge of the plate to serve as tip pockets, the hard alloy tips embedded into the tip pockets and welded onto the plate through brazing solder. Since the half bottom of the hard alloy tip is buried into the tip pocket, the impact resistance of the hard alloy tip is improved structurally, and the area of the brazing layer is enlarged, which increases the bonding strength.

Furthermore, the hard alloy tips are resistance-welded without solder to the outer edge of the steel plate, and the bottom of the hard alloy tips is arc-shaped.

Furthermore, the depth of the tip pocket ranges 0.5-3.0 mm.

Furthermore, the thickness of the plate ranges 0.5-2.5 mm, and the outer diameter of the plate ranges 50-400 mm.

Furthermore, the tip is made of hard alloy, the maximum dimension range thereof is controlled to be 1-5 mm and the small size tip adopted is economical and environment-friendly which also meets the requirement of strictly controlling the extended length of each tip.

Furthermore, the length of tips extended from the plate ranges 0.5-3.0 mm.

Advantageous effects are obtained by adopting above technical plan:

(1) The plate in the invention is a non-toothed structure with smooth outer edge so as to be more stable when the saw blade cuts workpiece at a high speed, reducing risk of body's crushing; meanwhile, the hard alloy tip has small extended length, greatly reducing the breakage risk of alloy tips and enhancing the security of saw blade and having unique advantage when working with portable power tools.

(2) The invention adopts small-size hard alloy tip arranged in ordered array along outer edge of the plate and subjected to sharpening processing which is apt to cooperate with ultra-thin plate to process into ultra-thin saw blades, thus having wide market prospect on precision cutting and battery power tools.

The saw blade in the invention strictly controls the cutting depth of each tip, being easy to form multi-purpose saw blades and applicable to cut various materials, including wood, wood with nails, plastics, thin-wall aluminum materials, thin-wall steel profiles, stainless steel materials and the like, having huge market potential.

### BRIEF DESCRIPTION OF THE DRAWINGS

FIG. 1 is the overall structure diagram of embodiment 1 of the invention.

FIG. 2 is the enlarged schematic view of a single hard alloy tip embedded in a tip pocket of the plate in embodiment 1.

FIG. 3 is the overall structure diagram of embodiment 2 of the invention.

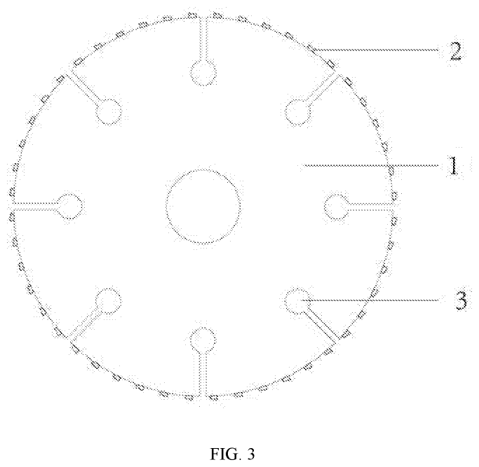

FIG. 4 is the enlarged schematic view of fusion zone of a single hard alloy tip fusion-welded onto the plate in embodiment 2.

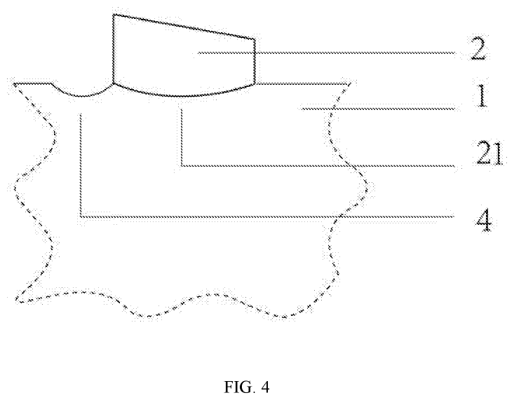

In the drawing, 1—plate; 2—hard alloy tip; 3—expansion slot; 4—shallow groove; 11—tip pocket; 12—brazing layer; 21—fusion zone.

### DETAILED DESCRIPTION OF THE PREFERRED EMBODIMENTS

The invention is further described in detail hereinafter with reference to the drawings.

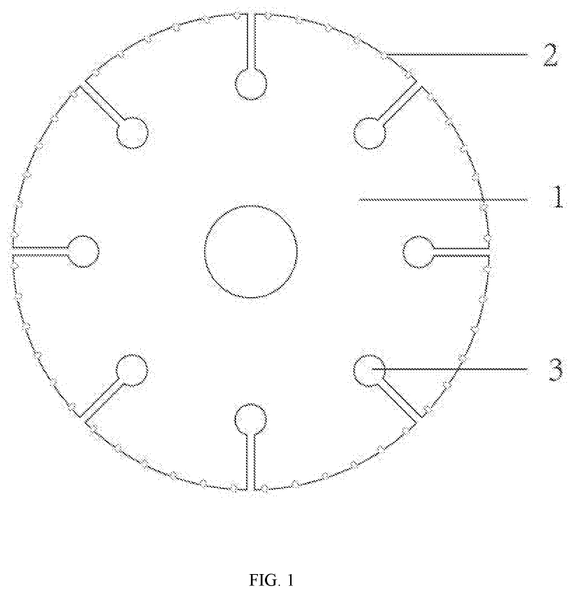

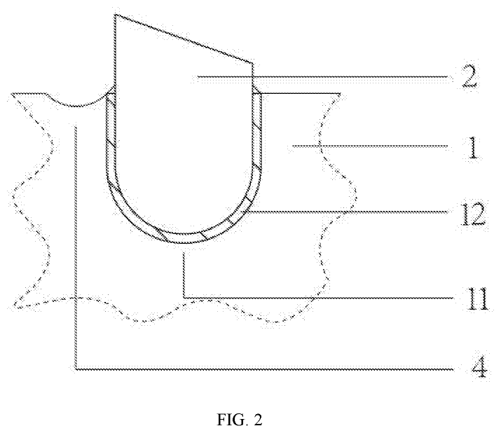

Embodiment 1: a non-toothed hard alloy tipped circular saw blade as shown in FIG. 1-FIG. 2 comprising a plate 1 which is a non-toothed circular structure with a smooth outer edge.

A plurality of hard alloy tips 2 are arranged in ordered array along the outer edge of the steel plate 1 and can be sharpened according to requirements.

The outer edge of the plate 1 can be arranged with expansion slots 3.

A plurality of grooves are formed in the outer edge of the plate 1 to serve as tip pockets 11. The hard alloy tip 2 are embedded into the tip pocket 11 and welded into the plate 1 through brazing solder and brazing layer 12 is formed at welding point. The half bottom of the hard alloy tip 2 is buried into the tip pocket 11, the impact resistance of the hard alloy tip 2 improved structurally, and the area of the brazing layer 12 is enlarged, which increases the bonding strength.

The depth of the tip pocket 11 ranges 0.5-3.0 mm.

The thickness of the plate 1 ranges 0.5-2.5 mm, and the outer diameter of the plate 1 ranges 50-400 mm.

The tip 2 is made of hard alloy, the maximum dimension range thereof is controlled to be 1-5 mm and the small size tip adopted is economical and environment-friendly which also meets the requirement of strictly controlling the extended length of each tip.

The length of tips 2 extended from the plate 1 ranges 0.5-3.0 mm.

The plate 1 of the invention is used for providing support for the hard alloy tip 2, the expansion slot 3 can help dissipate the heat and absorb the thermal expansion of the plate 1 in the whole working process.

The hard alloy tip 2 and the plate 1 in embodiment 1 are firmly connected through brazing solder in a high-frequency brazing mode. The tip pocket 11 is designed to bury the bottom of hard alloy tip 2, which makes the impact resistance of the hard alloy tips 2 improved structurally and the area of the brazing layer 12 enlarged, thus increasing the bonding strength. The existence of brazing layer 12, as a transition layer, can make a wider selection of tip's material and after welding. The hard alloy tips 2 can be prevented from cracking during the cooling process.

According to different cutting objects and processing requirements, the embodiment 1 employ a diamond grinding wheel to grind a specific angle on each tip face, then to form a specific geometric shape.

Wherein, in the sharpening process of the tip's hook angle, overshoot is probably occurred due to the small extended length of the tip 2, and a shallow groove 4 can be generated on the outer circumference of the plate 1, which is beneficial to the diversion and chips' removal in the cutting process of the saw blade.

Embodiment 2: a non-toothed hard alloy tipped circular saw blade as shown in FIG. 1-FIG. 2 comprising a plate 1 which is a non-toothed circular structure with a smooth outer edge.

Along outer edge of the plate 1 is arranged with a plurality of hard alloy tips 2 in ordered array and each hard alloy tip 2 is subjected to sharpening processing according to requirements.

The outer edge of the plate 1 can be arranged with expansion slots 3; the hard alloy tips 2 are resistance-welded without solder to the outer edge of the steel plate 1, and the bottom of the hard alloy tips 2 is arc-shaped.

The hard alloy tips 2 are resistance-welded without solder to the outer edge of the steel plate 1, and the bottom of the hard alloy tips 2 is arc-shaped, and the fusion welding position of hard alloy tip 2 is fusion zone 21.

The thickness of the plate 1 ranges 0.5-2.5 mm, and the outer diameter of the plate 1 ranges 50-400 mm.

The tip 2 is made of hard alloy, the maximum dimension range thereof is controlled to be 1-5 mm and the small size tip 2 adopted is economical and environment-friendly which also meets the requirement of strictly controlling the extended length of each tip 2.

The length of tips 2 extended from the plate 1 ranges 0.5-3.0 mm.

The plate 1 of the invention is used for providing support for the hard alloy tip 2, the expansion slot 3 can help dissipate the heat and absorb the thermal expansion of the plate 1 in the whole working process.

When the solder-free welding is adopted, the alloy tip 2 and the plate 1 are subjected to direct fusion welding, so the bonding strength is high and no tip pocket 11 is needed, which comprises the following steps: fixing the alloy tip 2 on the outer edge of the plate 1, melting their contact position via large current and exerting pressure at the same time to complete the resistance welding process.

The hard alloy tip 2 and the plate 1 in the embodiment are connected in a solder-free brazing mode and the bottom of the small hard alloy tip 2 is arc-shaped; point contact is apt to form local large resistance, generate high temperature and form a metal molten pool. After welding is finished, according to different cutting objects and processing requirements, the embodiment 2 employ a diamond grinding wheel to grind a specific angle on each tip face, then to form a specific geometric shape.

In the sharpening process of the tip's hook angle, overshoot is probably occurred due to the small extended length of the tip 2, and a shallow groove 4 can be generated on the outer circumference of the plate 1, which is beneficial to the diversion and chips' removal in the cutting process of the saw blade.

The hard alloy tip 2 of the invention can be designed differently according to different processing objects and processing requirements, but the overall principle is not changed.

As may be recognized by those of ordinary skill in the pertinent art, the detailed descriptions of the two above embodiments of the invention are intended to illustrate and not to limit this invention. Various changes and modifications may be made to the embodiments without departing from the spirit and scope of the invention. Any equivalent changes or modifications made according to the spirit disclosed by the invention shall fall within the protection scope of the invention.

1. A non-toothed hard alloy tipped circular saw blade, comprising: a non-toothed structure steel plate with smooth outer edge; a plurality of hard alloy tips arranged in ordered array along the outer edge of the steel plate and can be sharpened according to requirements.

2. The non-toothed hard alloy tipped circular saw blade of claim 1, wherein a plurality of grooves are formed in the outer edge of the steel plate to serve as tip pockets, the hard alloy tips are embedded into the pocket and welded onto the steel plate through brazing solder.

3. The non-toothed hard alloy tipped circular saw blade of claim 1, wherein the hard alloy tips are resistance-welded without solder to the outer edge of the steel plate, and the bottom of the hard alloy tips is arc-shaped.
